(19) United States
(12) Patent Application Publication
(10) Pub. No.: US 2024/0147891 A1
(43) Pub. Date: May 9, 2024

(54) Agricultural Land Roller Implement with Transport Wheel Arrangement Having a Reduced Turning Radius

(71) Applicant: J A REDEKOP HOLDINGS LTD., Winkler (CA)

(72) Inventors: Waldemar Berg, Winkler (CA); Martin Grass, Winkler (CA); Johan Redekop, Winkler (CA)

(21) Appl. No.: 17/982,893

(22) Filed: Nov. 8, 2022

(51) Int. Cl. A01B 73/06; A01B 29/02

(52) U.S. Cl. CPC A01B 73/067; A01B 29/02

(57) ABSTRACT

A land roller implement is towed by an agricultural tractor for levelling land. The implement has a main frame and two wing assemblies pivotal from a working field position extending laterally outward in opposing directions from the main frame to a transport position extending rearwardly from the main frame. The implement has a set of transport wheels for transporting the rollers of the implement spaced above the ground in the transport position, the wheels including: (i) two leading wheels on the main frame, (ii) two trailing wheels at the outer ends of wing assemblies, and (iii) two steerable wheels supported on the wing assemblies forwardly of the trailing wheels. The steerable wheels can be controllably pivoted by an actuator into a transport configuration oriented for forward rolling in transport, while the other wheels are freely pivotal to shorten the turning radius of the towed implement.

### FIELD OF THE INVENTION

The present invention relates to an agricultural land roller implement comprising a plurality of frame sections having land levelling rollers thereon in which the frame sections which are foldable relative to one another from a laterally oriented working position to a trailing transport position, and more particularly the present invention relates to a land roller implement having an arrangement of transport wheels that can be deployed to support the land levelling rollers above the ground when trailing a towing vehicle in transport position.

### BACKGROUND

Land roller implements are commonly used in agriculture for levelling land, pushing rocks down into the soil, breaking up soil mounds and clods, or packing seed for example. A typical land roller includes a plurality of frame sections, each supporting at least one roller thereon. The roller may be a steel drum, a series of packer wheels or any other rolling packing element. Due to the low draft resulting from the rolling movement of the rollers over the ground and the desirability to cover as much area as possible with each pass over an agricultural field with the implement, land roller implements are known to deploy wings comprised of two or more sections each extending laterally outward from opposing sides of a center section. These wings are then folded rearwardly in trailing relationship from the center section in a transport position with transport wheels that are deployed to support the rollers spaced above the ground.

U.S. Pat. No. 8,820,428 by McCrea et al discloses a land roller implement having transport wheels at the trailing end of each wing section which can be pivoted between a field position shown in FIG. 5 in which the wheel is oriented for rolling with the roller and a transport position shown in FIG. 6 in which the wheel is rotated through 90 degrees about an upright steering axis from the field position to be oriented at right angles to the roller. The transport wheel at the trailing end of each wing section must be locked in the transport position while transporting the implement along a roadway due to the instability resulting from the lateral offset location of the upright steering axis relative to the transport wheel. The turning radius of the implement when towing the implement in the transport position is very large due to the fixed orientation of the transport wheel at the trailing end of each wing section so that it can be difficult to manoeuvre the implement.

### SUMMARY OF THE INVENTION

According to one aspect of the invention there is provided a land roller implement arranged to be towed in a forward working direction by a towing vehicle for flattening and levelling land, the implement comprising:
(a) a main frame section arranged for connection to the towing vehicle, the main frame section supporting a main roller thereon for rolling movement in the forward working direction;
(b) two wing assemblies extending along respective longitudinal axes from inner ends of the wing assemblies to outer ends of the wing assemblies respectively, the inner ends of the wing assemblies being pivotally coupled at opposing sides of the main frame section respectively whereby the wing assemblies are movable relative to the main frame section between a working position in which the longitudinal axes of the wing assemblies extend laterally outward in opposing directions from the main frame section and a transport position in which the longitudinal axes of the wing assemblies extend rearwardly from the main frame section;
(c) each wing assembly comprising:
   (i) an outer frame section at the outer end of the wing assembly, the outer frame section including an outer roller supported thereon for rolling movement in the forward working direction in the working position of the wing assembly;
   (ii) an intermediate frame section supported between the outer frame section and the inner end of the wing assembly, the intermediate frame section including an intermediate roller supported thereon for rolling movement in the forward working direction in the working position of the wing assembly; and
   (iii) an inner end of the outer frame section being coupled to an outer end of the intermediate frame section;
(d) set of transport wheels supporting the frame sections for rolling movement in the forward working direction in the transport position, the set of transport wheels including:
   (i) two leading wheel assemblies supported on the main frame section;
   (ii) two trailing wheel assemblies supported at the outer ends of the outer frame sections respectively, each trailing wheel assembly including at least one trailing wheel; and
   (iii) two steerable wheel assemblies supported on the wing assemblies respectively at a location nearer to the inner ends of the wing assemblies than the trailing wheel assemblies, each steerable wheel assembly including an actuating arrangement associated with the steerable wheel assembly, the actuating arrangement being arranged to controllably pivot the steerable wheel about an upright steering axis between a transport configuration oriented for rolling movement about a wheel axis lying perpendicularly to the longitudinal axis of the wing assembly and a field configuration oriented transversely to the transport configuration;
(e) each steerable wheel assembly being supported on the respective wing assembly adjacent to a connection of the inner end of the outer frame section and the outer end of the intermediate frame section; and
(f) said at least one trailing wheel of each trailing wheel assembly is supported for free pivotal movement about an upright caster axis of the trailing wheel assembly and said at least one trailing wheel being laterally centered relative to the caster axis of the trailing wheel assembly in a trailing relationship with the caster axis.

By locating a steerable wheel that can be fixed in a transport orientation at a location spaced forward from a free pivoting trailing wheel, a considerable length at the trailing end of each wing remains well supported by the transport wheels for rolling movement in the forward working direction, while the steerable wheels define a much shorter turning radius that is comparable with much shorter implements. This increases the manoeuvrability of the implement when towing in the transport position. Each actuating arrangement may be further arranged to lock the associated steerable wheel assembly in the transport configuration.

Each actuating arrangement may be arranged to pivot the associated steerable wheel assembly between the transport configuration and the field configuration through a range of less than 90 degrees whereby the wheel axis of the steerable wheel assembly is oriented transversely to the longitudinal axis of the wing assembly in the field configuration.

Preferably each actuating arrangement is arranged to pivot the associated steerable wheel assembly between the transport configuration and the field configuration through a range of less than 60 degrees, and more preferably through a range of approximately 45 degrees.

When each steerable wheel assembly is supported on a first one of the inner end of the outer frame section or the outer end of the intermediate frame section of the wing assembly, the set of transport wheels may further comprise an intermediate wheel assembly supported on each wing assembly. In this instance, (i) the intermediate wheel assembly is supported on a second one of the inner end of the outer frame section or the outer end of the intermediate frame section of the wing assembly, (ii) the intermediate wheel assembly is supported for free pivotal movement about an upright caster axis of the intermediate wheel assembly, and (iii) the intermediate wheel assembly comprises at least one intermediate wheel in which said at least one intermediate wheel is laterally centered relative to the caster axis of the intermediate wheel assembly in a trailing relationship with the caster axis.

In the illustrated embodiment, each steerable wheel assembly is supported on the inner end of the outer frame section of the respective wing assembly.

When two intermediate wheel assemblies are supported on the wing assemblies respectively, each intermediate wheel assembly is preferably supported on the outer end of the intermediate frame section of the respective wing assembly. In this instance, each intermediate wheel assembly is preferably supported for free pivotal movement about an upright caster axis of the intermediate wheel assembly and the intermediate wheel assembly of each wing assembly preferably comprises at least one intermediate wheel in which said at least one intermediate wheel is laterally centered relative to the caster axis of the intermediate wheel assembly in a trailing relationship with the caster axis.

Each wing assembly may further include an inner frame section supported between the intermediate frame section and the inner end of the wing assembly such that an inner end of the intermediate frame section is supported on an outer end of the inner frame section, in which the inner frame section includes an inner roller supported thereon for rolling movement in the forward working direction in the working position of the wing assembly.

The implement may further include two inner wheel assemblies supported on the two wing assemblies respectively in which (i) each inner wheel assembly is supported on a first one of the outer end of the inner frame section or the inner end of the intermediate frame section of the respective wing assembly, (ii) the inner wheel assembly is supported for free pivotal movement about an upright caster axis of the inner wheel assembly, and (iii) the inner wheel assembly of each wing assembly comprises at least one inner wheel in which said at least one inner wheel is laterally centered relative to the caster axis of the inner wheel assembly in a trailing relationship with the caster axis.

The implement may further include two auxiliary wheel assemblies supported on the two wing assemblies respectively in which (i) each auxiliary wheel assembly is supported on a second one of the outer end of the inner frame section or the inner end of the intermediate frame section of the respective wing assembly, (ii) the auxiliary wheel assembly is supported for free pivotal movement about an upright caster axis of the auxiliary wheel assembly, and the auxiliary wheel assembly of each wing assembly comprises at least one auxiliary wheel in which said at least one auxiliary wheel is laterally centered relative to the caster axis of the auxiliary wheel assembly in a trailing relationship with the caster axis.

According to a further embodiment, each steerable wheel assembly may be supported on the outer end of the intermediate frame section of the respective wing assembly. In this instance, two intermediate wheel assemblies may be supported on wing assemblies respectively in which (i) the intermediate wheel assembly is supported on the inner end of the outer frame section of the respective wing assembly, (ii) each intermediate wheel assembly being supported for free pivotal movement about an upright caster axis of the intermediate wheel assembly, and (iii) the intermediate wheel assembly of each wing assembly comprising at least one intermediate wheel in which said at least one intermediate wheel is laterally centered relative to the caster axis of the intermediate wheel assembly in a trailing relationship with the caster axis. In this instance, the inner ends of the intermediate frame sections are preferably directly connected to the main frame section.

### BRIEF DESCRIPTION OF THE DRAWINGS

Some embodiments of the invention will now be described in conjunction with the accompanying drawings in which:

FIG. 1 is a perspective view of a first embodiment of the land roller implement in a transport position;

FIG. 2 is a top plan view of the land roller implement according to the first embodiment of FIG. 1 in the transport position, showing the steerable wheels in a field deployment orientation for rolling rearwardly at a laterally outward slope to steer and deploy the wing assemblies from the transport position to the working field position when the implement is reversed across a field;

FIG. 3 is a side elevational view of the land roller implement according to the first embodiment of FIG. 1 in the transport position;

FIG. 4 is a top plan view of the land roller implement according to the first embodiment of FIG. 1 in the working field position;

FIG. 5 is a front elevational view of the land roller implement according to the first embodiment of FIG. 1 in the working position;

FIG. 6 is a perspective view of one of the steerable wheel assemblies of the land roller implement according to the first embodiment of FIG. 1 in a lowered transport configuration;

FIG. 7 is a side view of the steerable wheel assembly of FIG. 6 in the lowered transport configuration;

FIG. 8 is a side view of the steerable wheel assembly of FIG. 6 in a raised field configuration;

FIG. 9 is a top plan view of the steerable wheel assembly of FIG. 6 in a road transport orientation for rolling in the forward working direction with the implement in the transport position;

FIG. 10 is a top plan view of the steerable wheel assembly of FIG. 6 in the field deployment orientation;

FIG. 11 is a perspective view of one of the auxiliary wheel assemblies in a lowered transport configuration in which the inner wheel assemblies and the intermediate wheel assemblies are substantially identical to the auxiliary wheel assemblies;

FIG. 12 is a side view of the inner or auxiliary or intermediate wheel assembly of FIG. 11 in the lowered transport configuration;

FIG. 13 is a side view of the inner or auxiliary or intermediate wheel assembly of FIG. 11 in a raised field configuration;

FIG. 14 is a top view of one of the trailing wheel assemblies in a lowered transport configuration;

FIG. 15 is a side view of the trailing wheel assembly of FIG. 13 in the lowered transport configuration;

FIG. 16 is a side view of the trailing wheel assembly of FIG. 13 in a raised field configuration;

FIG. 17 is a top plan view of the land roller according to a second embodiment with the wing assemblies in a working field position; and

FIG. 18 is a top plan view of the land roller implement according to the second embodiment of FIG. 17 showing the wing assemblies in a transport position and the steerable wheels in a field deployment orientation for rolling rearwardly at a laterally outward slope to steer and deploy the wing assemblies from the transport position to the working field position when the implement is reversed across a field.

In the drawings like characters of reference indicate corresponding parts in the different figures.

### DETAILED DESCRIPTION

Referring the accompanying figures there is illustrated a land roller implement generally indicated by reference numeral 10. The land roller implement 10 is suited for connection to a towing vehicle to be towed in a forward working direction for flattening and levelling land across which the implement is displaced. A typical towing vehicle with which the implement is associated is an agricultural tractor (not shown) including a hitch for connecting to the implement and a hydraulic system providing a supply of hydraulic fluid for controlling the various actuators of the implement as described in further detail below.

The implement supports various rollers thereon which are rolled across a ground surface to be levelled when the implement is in use in a working position. In the working position, the rolling axes of the rollers are oriented in a lateral direction perpendicular to the forward working direction of the towing vehicle while extending laterally outward from opposing sides of the vehicle for maximum coverage of the ground surface across which the implement is towed. The rollers can be displaced from the working position into a transport position in which the rolling axes of the rollers extend longitudinally rearward in a trailing relationship while being suspended spaced above the ground to reduce the overall width in the lateral direction for transport between different locations of use.

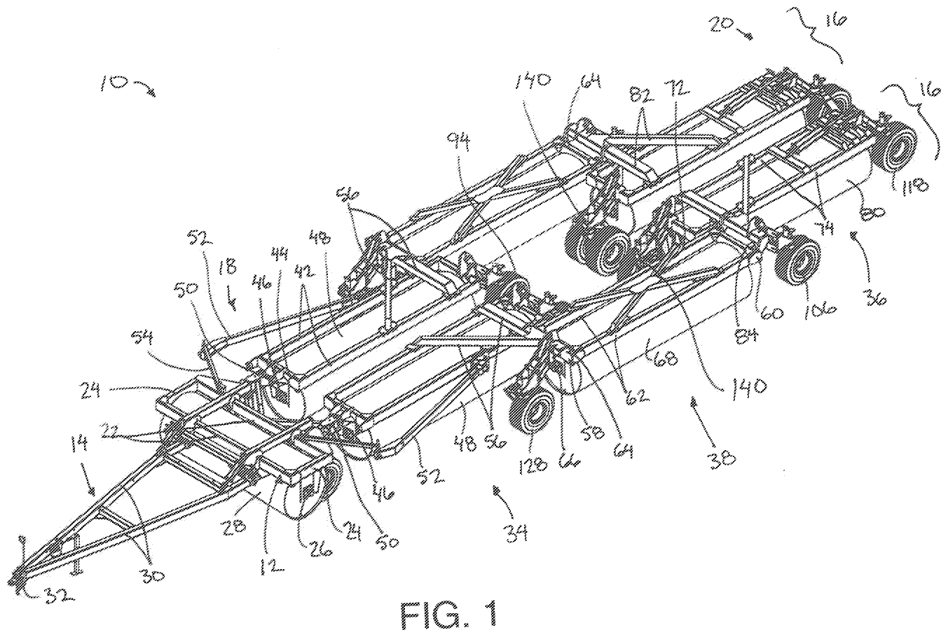

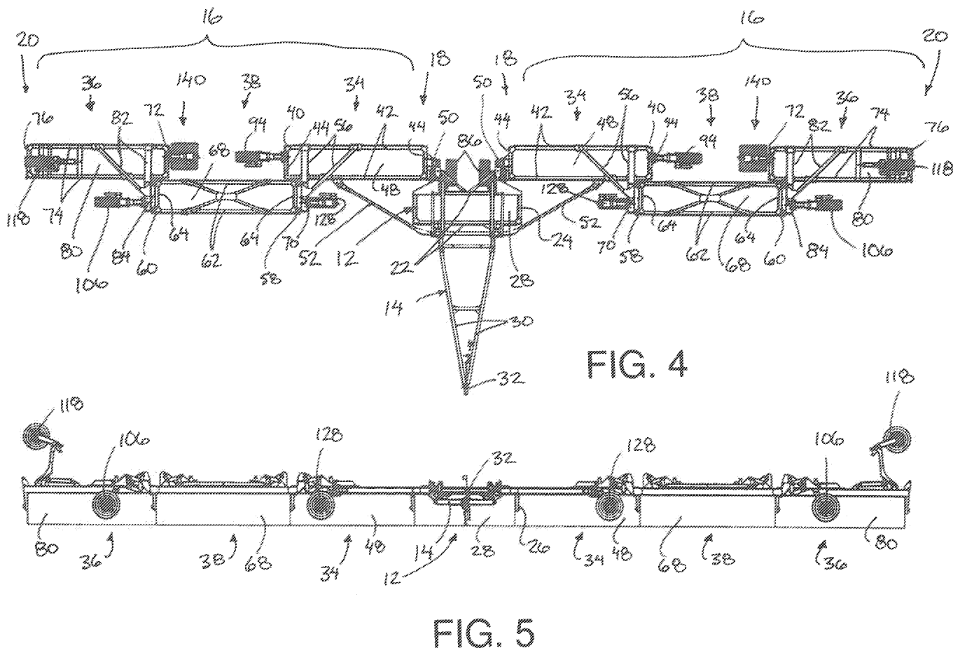

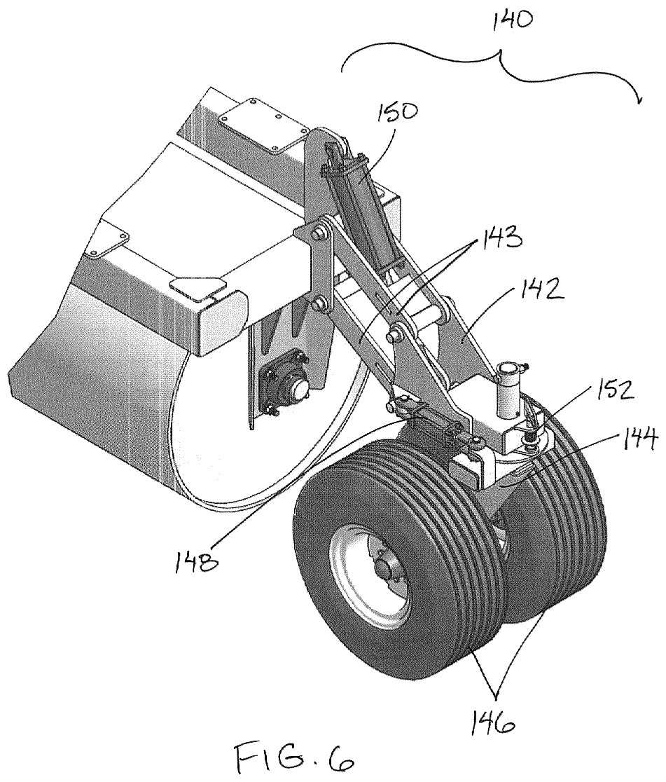

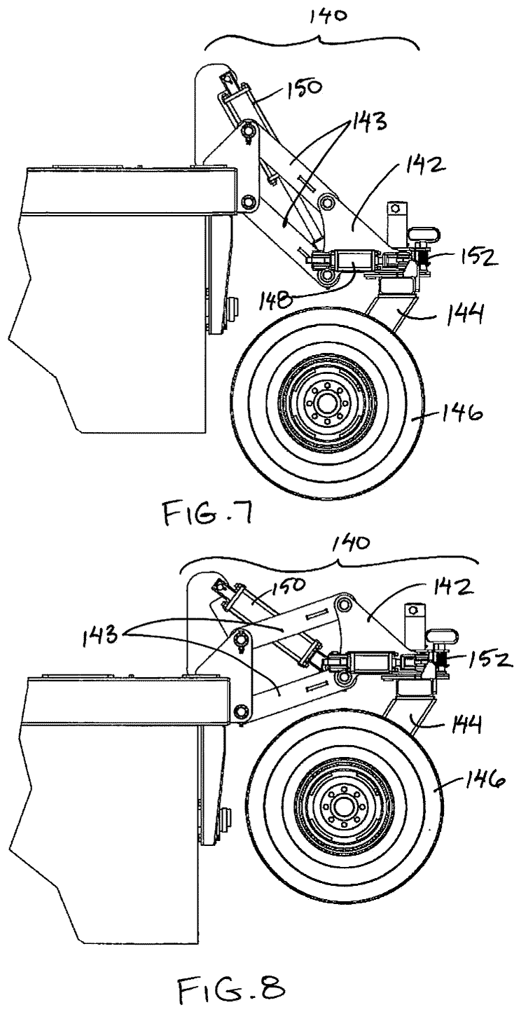

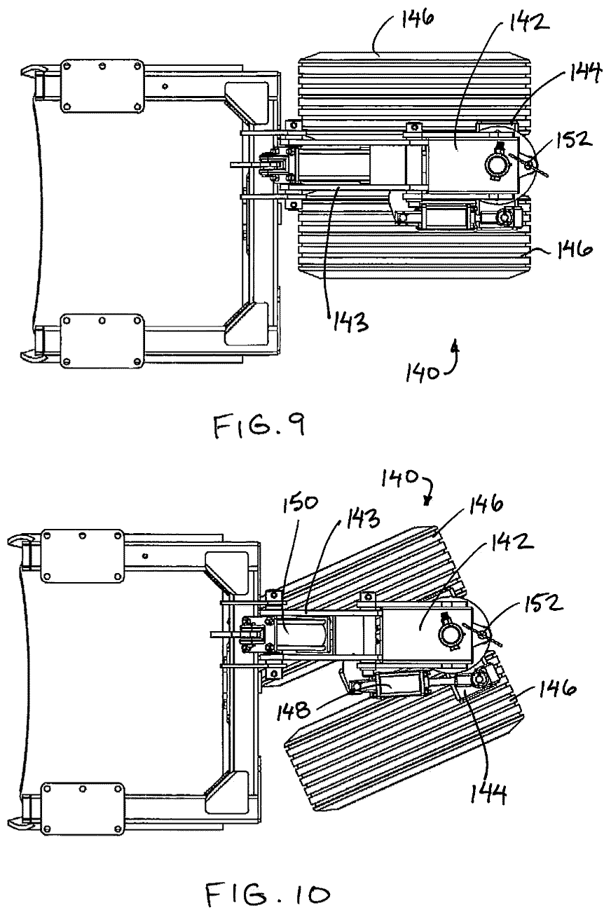

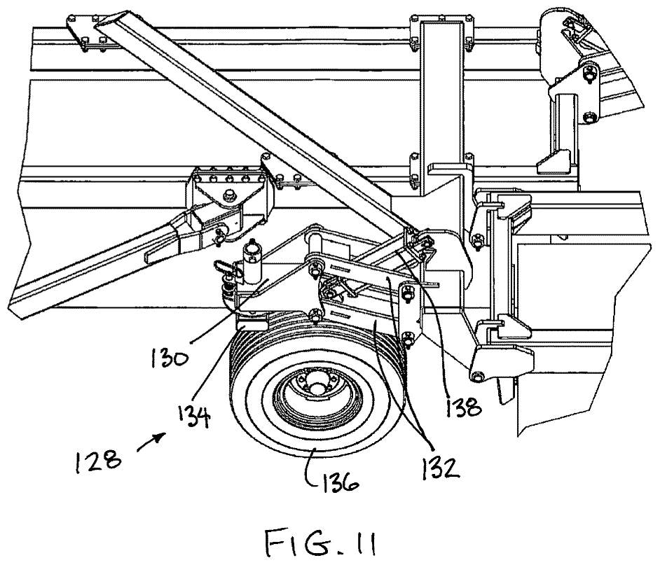

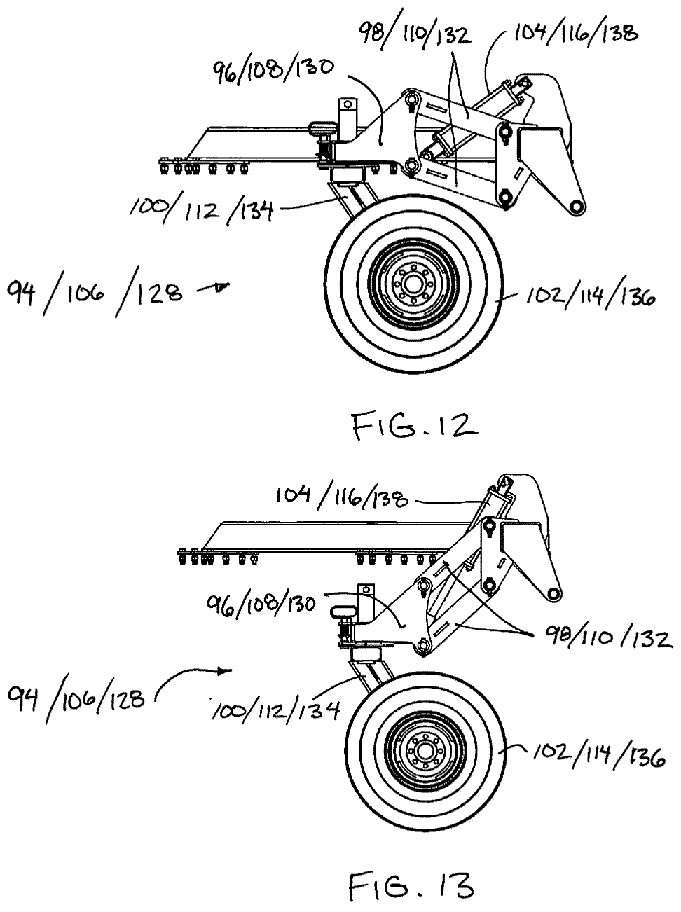

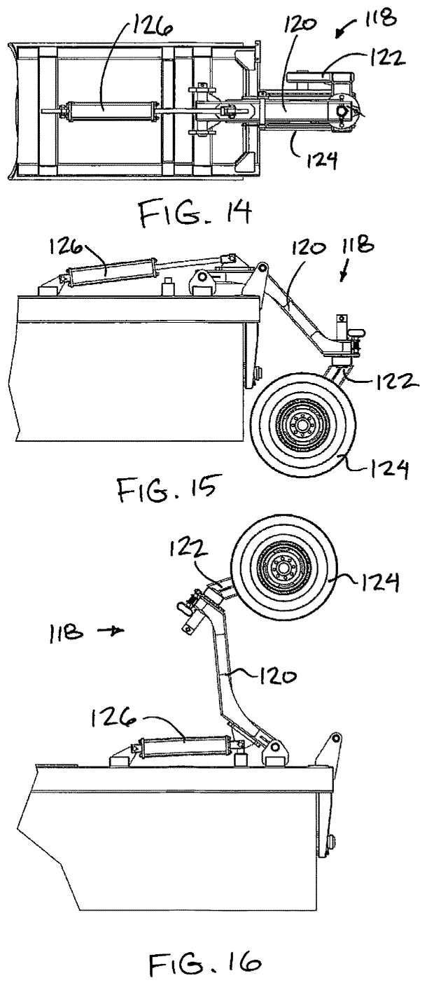

Turning now to the first embodiment of the implement 10 shown in FIGS. 1 through 16, in this instance the structural frame of the implement includes a main frame section 12 from which a hitch frame 14 protrudes forwardly for connection to the towing vehicle, and two wing assemblies 16 which are coupled at opposing sides of the main frame section 12. Each wing assembly 16 is elongate along a respective longitudinal axis from an inner end 18 of the wing assembly that is coupled to the main frame section 12 to an outer end 20 that is distal relative to the main frame section 12. In the working position when the implement is used for leveling land, the wing assemblies are supported to extend laterally outward in opposing directions from the main frame section 12. In the transport position, the two wing assemblies 16 extend rearward from the main frame section 12 to be substantially parallel to one another when towed in the forward working direction.

The main frame section 12 is comprised of two longitudinal beams 22 which extend laterally across the full width of the main frame section between opposing ends at respective front and rear sides of the main frame section. A pair of crossbars 24 are connected between the longitudinal beams 22 at the laterally opposing ends. A support member 26 including bearings mounted therein extends downward from each crossbar 24 to support opposing ends of a main roller 28 rotatably thereon such that the main roller 28 is oriented for rolling movement in the forward working direction about an axis oriented perpendicularly to the forward working direction.

The hitch frame 14 comprises two frame members 30 which are coupled at rear ends at laterally spaced apart positions along the forward longitudinal beam 22. The frame members 30 are tapered inwardly towards one another from the rear ends to the front ends thereof such that the front ends are joined at a hitch connector 32 which serves to form a towing connection to the hitch of the tow vehicle.

In the first embodiment, each wing assembly includes an inner frame section 34 at the inner end 18 of the wing assembly, an outer frame section 36 at the outer end of the wing assembly, and an intermediate frame section 38 extending longitudinally between the inner frame section 34 and the outer frame section 36 of the wing assembly.

Each inner frame section 34 extends longitudinally between the inner end 18 of the wing assembly coupled to the main frame section to an opposing outer end 40 of the inner frame section onto which the intermediate frame section of the wing assembly is supported. Each inner frame section comprises two longitudinal beams 42 extending longitudinally between opposing ends of the inner frame section at opposing front and rear sides of the frame section in the working position. The longitudinal beams 42 are joined with one another at the opposing ends by crossbars 44. A pair of support members 46 including bearings mounted therein extend downward from the crossbars 44 respectively to support opposing ends of an inner roller 48 rotatably thereon such that the inner roller is oriented for rolling movement in the forward working direction about an axis oriented parallel to the longitudinal axis of the wing assembly and perpendicularly to the forward working direction in the working position. The inner roller spans the full length of the inner frame section and is oriented for rolling movement in the forward working direction in the working position.

A pivot coupling 50 is operatively connected between the inner end of each inner frame section and a respective mounting location on the main frame section in the form of a two axis universal joint. More particularly, each pivot coupling 50 serves to couple the wing assembly to the main frame section for pivotal movement about a vertical axis between the working and transport positions of the wing assemblies respectively, while also coupling the wing assembly for pivotal movement relative to the main frame section about a horizontal axis that is oriented perpendicularly to the longitudinal axis of the wing assembly for following various ground contours and for flexing of the overall structural frame in both the working and transport positions respectively.

A brace arm 52 is pivotally coupled on a forwardmost longitudinal beam 42 of each inner frame section for selective connection to the main frame section at a location forwardly of the respective pivot coupling 50 to provide bracing for the wing assemblies to remain perpendicular to the forward working direction in the working position of the implement. The brace arms 52 can be released at the forward ends thereof for releasing the wing assemblies into the transport position. A connecting link 54 is associated with each brace arm 52 to support the forward end of the brace arm in the transport position when the forward ends are disconnected from respective mounting locations in the working position.

Each inner frame section 34 further includes a mounting frame comprised of two mounting frame members 56 which are mounted transversely across the two longitudinal beams 42, in proximity to the outer end 40 of the inner frame section, so that the mounting frame members 56 protrude laterally outwardly from the inner frame section 34 by a width of the intermediate frame sections in the transport position. More particularly the two mounting frame members 56 are joined to one another at the distal ends relative to the inner frame section to form a triangular arrangement with the rearward longitudinal beam 42 of the inner frame section. Each mounting frame receives the inner end of the respective intermediate frame section 38 of the wing assembly mounted thereon at the distal ends of the mounting frame members so as to support the intermediate frame sections offset laterally outwardly relative to the inner frame sections in the transport position, corresponding to the intermediate frame section 38 being positioned forwardly of the inner frame sections 34 in the working position.

Each intermediate frame section 38 extends longitudinally between a respective inner end 58 of the intermediate frame section which is coupled onto the mounting frame at the outer end of the respective inner frame section 34 and a longitudinally opposed outer end 60. Each intermediate frame section comprises two longitudinal beams 62 extending longitudinally between opposing ends of the intermediate frame section at opposing front and rear sides of the frame section in the working position. The longitudinal beams 62 are joined with one another at the opposing ends by crossbars 64. A pair of support members 66 including bearings mounted therein extend downward from the crossbars 64 respectively to support opposing ends of an intermediate roller 68 rotatably thereon such that the intermediate roller is oriented for rolling movement in the forward working direction about an axis oriented parallel to the longitudinal axis of the wing assembly and perpendicularly to the forward working direction in the working position. The intermediate roller spans the full length of the intermediate frame section and is oriented for rolling movement in the forward working direction in the working position.

Two pivots 70 are supported at spaced apart positions across the leading crossbars 64 of the intermediate frame section in the transport position for pivotal connection to one of the frame members 56 of the mounting frame of the inner frame section that is perpendicular to the forward working direction in the transport position. The two pivots 70 serve to couple the intermediate frame section to the respective inner frame section for relative pivotal movement about a horizontal floating axis oriented perpendicularly to the longitudinal axis of the wing assembly for providing flexibility to the structural frame to follow varying ground contours in the transport and working positions. The mounting frame members 56 are positioned slightly inwardly of the outer end of the inner frame section 34 such that the intermediate roller 68 longitudinally overlaps the inner roller 48 in the longitudinal direction of each wing assembly. This is accomplished by offsetting the intermediate frame section 38 laterally outwardly relative to the inner frame sections in the transport position, corresponding to the intermediate rollers being offset forwardly of the inner rollers in the working position.

Each outer frame section 36 extends longitudinally between an inner end 72 of the frame section and an opposing outer end of the frame section defining the outer end 20 of the overall wing assembly. The inner end 72 of each outer frame section 36 is coupled to the outer end of the corresponding intermediate frame section 38. Each outer frame section comprises two longitudinal beams 74 extending longitudinally between opposing ends of the outer frame section at opposing front and rear sides of the frame section in the working position. The longitudinal beams 74 are joined with one another at the opposing ends by crossbars 76. A pair of support members 78 including bearings mounted therein extend downward from the crossbars 76 respectively to support opposing ends of an outer roller 80 rotatably thereon such that the outer roller is oriented for rolling movement in the forward working direction about an axis oriented parallel to the longitudinal axis of the wing assembly and perpendicularly to the forward working direction in the working position. The outer roller 80 spans the full length of the outer frame section and is oriented for rolling movement in the forward working direction in the working position.

Each outer frame section further includes a mounting frame comprised of two mounting frame members 82 which are mounted transversely across the two longitudinal beams 74, in proximity to the inner end 72 of the outer frame section so that the mounting frame members 82 protrude laterally outwardly from the outer frame section by a width of the intermediate frame sections in the transport position. The mounting frame members 82 are joined to one another at the distal ends relative to the outer frame section to form a triangular arrangement with the rearward longitudinal beam 74 of the outer frame section. The mounting frame of each wing assembly receives the outer end of the respective intermediate frame section 38 of the wing assembly mounted thereon at the distal ends of the mounting frame members 82 to support the outer frame sections offset laterally inwardly relative to the intermediate frame sections in the transport position, corresponding to the outer frame sections being positioned rearwardly of the intermediate frame sections in the working position.

Two pivots 84 are supported at spaced apart positions across the trailing crossbar 64 of the intermediate frame section in the transport position for pivotal connection to one of the frame members 82 of the mounting frame of the outer frame section that is perpendicular to the forward working direction and the transport position. The two pivots 84 serve to couple the outer frame section to the intermediate frame section for relative pivotal movement about a horizontal floating axis oriented perpendicularly to the longitudinal axis of the wing assembly for providing flexibility to the structural frame to follow varying ground contours in the transport and working positions. The mounting frame members are positioned slightly outwardly of the inner ends of the outer frame sections respectively such that the intermediate roller 68 longitudinally overlaps the outer roller 80 in the longitudinal direction of each wing assembly. This is accomplished by offsetting the intermediate frame section laterally outwardly relative to the outer frame sections in the transport position, corresponding to the intermediate rollers being offset forwardly of the outer rollers in the working position.

The implement according to the first embodiment includes a set of transport wheels which serve to support the various rollers of the implement spaced above the ground when the implement is towed in the transport position.

The transport wheels include two leading wheel assemblies 86 which are laterally spaced apart along the rearmost longitudinal beam 22 of the main frame section. Each leading wheel assembly 86 includes a trailing arm or parallel arms (not shown) which are hinged by a horizontal axis pivot at a forward end on the main frame section and which supports a pair of leading wheels at the trailing end of the trailing arm. A leading wheel actuator (not shown) is operatively coupled between the main frame section and the trailing arms for raising and lowering the leading wheels relative to the main frame section. In a transport configuration, the wheels are lowered below the elevation of the bottom of the main roller for engaging the ground for rolling motion in the forward working direction while supporting the main roller spaced above the ground. In a working configuration, the actuators raise the trailing arm and the wheel supported thereon so that the bottom of the leading wheels is spaced above a bottom of the main roller and the leading wheels are out of use.

The leading wheels are supported for free pivotal movement about a vertical axis relative to the parallel arms that raise and lower the height of the leading wheels. The leading wheels being laterally centred relative to the vertical axis. A rotation axis of the leading wheels is spaced rearwardly in a trailing relationship relative to the vertical axis so that the leading wheels are self-steering in the forward working direction. For example, the leading wheels may be supported on a parallel set links to be raised and lowered substantially as described below with regard to the steerable wheels, but with the leading wheels instead being freely pivotal about the vertical axis thereof.

The transport wheels further include an inner wheel assembly 94 associated with each wing assembly in which the inner wheel assembly is supported at the outer end of the inner frame section. The inner wheel assembly includes a pivot frame 96 connected to the outer end of the inner frame section by a pair of parallel links 98 so that the pivot frame is adjustable in height relative to the inner frame section. The pivot frame 96 supports a vertical pivot thereon from which a wheel frame 100 is supported to extend downwardly and rearwardly from the caster axis of the vertical pivot so that the wheel frame is freely pivotal relative to the pivot frame. A single inner wheel 102 of the inner wheel assembly is supported at the trailing end of the wheel frame 100 in trailing relationship to the caster axis of the vertical pivot while being laterally centred relative to the pivot axis. An inner actuator 104 is operatively connected between the inner frame section and one of the links 98 or the pivot frame 96 to control raising and lowering of the inner wheel 102 relative to the inner roller between transport and working configurations thereof. In the transport configuration, the bottom of the inner wheel 102 is spaced below the bottom of the inner roller to support the roller spaced above the ground in the transport position. The free pivot enables the inner wheel to be self-steering relative to the vertical pivot axis which remains vertical as the parallel links 98 are pivoted relative to the inner frame section. In the working configuration of the implement, the inner wheel assembly is raised so that the bottom of the inner wheel is spaced above the bottom of the inner roller for rolling engagement of the inner roller across the ground without interference by the inner wheel.

The transport wheels further include an intermediate wheel assembly 106 associated with each wing assembly in which the intermediate wheel assembly is supported at the outer end of the intermediate frame section. The intermediate wheel assembly includes a pivot frame 108 connected to the outer end of the intermediate frame section by a pair of parallel links 110 so that the pivot frame is adjustable in height relative to the intermediate frame section. The pivot frame 108 supports a vertical pivot thereon from which a wheel frame 112 is supported to extend downwardly and rearwardly from the caster axis of the vertical pivot so that the wheel frame is freely pivotal relative to the pivot frame. A single intermediate wheel 114 of the intermediate wheel assembly is supported at the trailing end of the wheel frame 112 in trailing relationship to the caster axis of the vertical pivot while being laterally centred relative to the pivot axis. An intermediate actuator 116 is operatively connected between the intermediate frame section and one of the links 110 or the pivot frame 108 to control raising and lowering of the intermediate wheel 114 relative to the intermediate roller between transport and working configurations thereof. In the transport configuration, the bottom of the intermediate wheel 114 is spaced below the bottom of the intermediate roller to support the roller spaced above the ground in the transport position. The free pivot enables the intermediate wheel to be self steering relative to the vertical pivot axis which remains vertical as the parallel links 98 are pivoted relative to the intermediate frame section. In the working configuration of the implement, the intermediate wheel assembly is raised so that the bottom of the inner wheel is spaced above the bottom of the intermediate roller for rolling engagement of the intermediate roller across the ground without interference by the intermediate wheel.

The transport wheels further include a trailing wheel assembly 118 supported at the outer end of the outer frame section corresponding to the outer end of the wing assembly. The trailing wheel assembly comprises a single trailing arm 120 extending generally downwardly and rearwardly from a leading end pivotally coupled to the outer frame section to an opposing outer end. The outer end of the arm 120 supports a vertical pivot thereon defining a vertical caster axis when the trailing wheel assembly is in a working configuration. A wheel frame 122 is coupled to the arm 120 by the vertical pivot so that the wheel frame is freely pivotal about the caster axis relative to the arm 120. The wheel frame supports a single trailing wheel 124 thereon for rotation about a wheel axis that is supported in a trailing relationship to the caster axis while the single trailing wheel 124 is laterally centred relative to the caster axis such that the trailing wheel is self steering relative to the structural frame of the implement when towed in the forward working direction. A trailing actuator 126 is operatively connected between the outer frame section and the arm 120 to raise and lower the arm 120 relative to the outer frame section. In the transport configuration with the arm extending rearwardly at a downward slope, the bottom of the trailing wheel is spaced below the bottom of the outer roller to support the roller spaced above the ground. In the working configuration of the implement, the trailing actuator is actuated so that the arm 120 extends upwardly and rearwardly and the trailing wheel assembly is raised so that the bottom of the trailing wheel is spaced above the bottom of the outer roller for rolling engagement of the outer roller across the ground without interference by the trailing wheel.

The transport wheels further include an auxiliary wheel assembly 128 associated with each wing assembly in which the auxiliary wheel assembly is supported at the inner end of the intermediate frame section 36. The auxiliary wheel assembly includes a pivot frame 130 connected to the inner end of the intermediate frame section by a pair of parallel links 132 that extend forwardly in the transport position so that the pivot frame is adjustable in height relative to the outer frame section. The pivot frame 130 supports a vertical pivot thereon from which a wheel frame 134 is supported to extend downwardly and rearwardly from the caster axis of the vertical pivot so that the wheel frame is freely pivotal relative to the pivot frame. A single auxiliary wheel 136 of the auxiliary wheel assembly is supported at the trailing end of the wheel frame 134 in trailing relationship to the caster axis of the vertical pivot while being laterally centred relative to the pivot axis. An auxiliary actuator 138 is operatively connected between the intermediate frame section and one of the links 132 or the pivot frame 130 to control raising and lowering of the auxiliary wheel 136 relative to the outer roller between transport and working configurations thereof. In the transport configuration, the bottom of the auxiliary wheel 136 is spaced below the bottom of the intermediate roller to support the roller spaced above the ground in the transport position. The free pivot enables the auxiliary wheel to be self-steering relative to the vertical pivot axis which remains vertical as the parallel links 132 are pivoted relative to the intermediate frame section. In the working configuration of the implement, the auxiliary wheel assembly is raised so that the bottom of the auxiliary wheel is spaced above the bottom of the intermediate roller for rolling engagement of the intermediate roller across the ground without interference by the auxiliary wheel.

The transport wheels further include a steerable wheel assembly 140 associated with each wing assembly in which the steerable wheel assembly is supported at the inner end of the outer frame section 36. The steerable wheel assembly includes a pivot frame 142 connected to the inner end of the outer frame section by a pair of parallel links 143 that extend generally forwardly from the outer frame section to the pivot frame 142 so that the pivot frame is adjustable in height relative to the outer frame section while a pivot axis of a pivot of the pivot frame 142 remains vertically oriented throughout the height adjustment. A wheel frame 144 extends downwardly and rearwardly from the pivot on the pivot frame so that the wheel frame is pivotal relative to the pivot frame about a vertical steering axis of the pivot on the pivot frame 142. Two steerable wheels 146 are rotatably mounted on the pivot frame for rotation about a common wheel axis that is spaced rearwardly of the vertical steering axis by the downward and rearward slope of the wheel frame 144. The collective arrangement of the two steerable wheels 146 is laterally centred relative to the upright steering axis. A steering actuator 148 is operatively connected between the pivot frame and the wheel frame to control orientation of the wheel frame and the steerable wheels 146 supported thereon relative to the pivot frame about the upright steering axis.

A lift actuator 150 is operatively connected between the outer frame section and one of the pivot frame 142 or the parallel links 143 so that height of the steerable wheels 146 relative to the outer roller can be controlled. In the transport configuration, with the links extending forwardly at a downward slope, the bottom of the steerable wheels is spaced below the bottom of the outer roller to support the outer roller spaced above the ground. In the working configuration of the implement, the lift actuator 150 is actuated so that the links extend upwardly and forwardly and the steerable wheels are raised so that the bottom of the steerable wheels is spaced above the bottom of the outer roller for rolling engagement of the outer roller across the ground without interference from the steerable wheels.

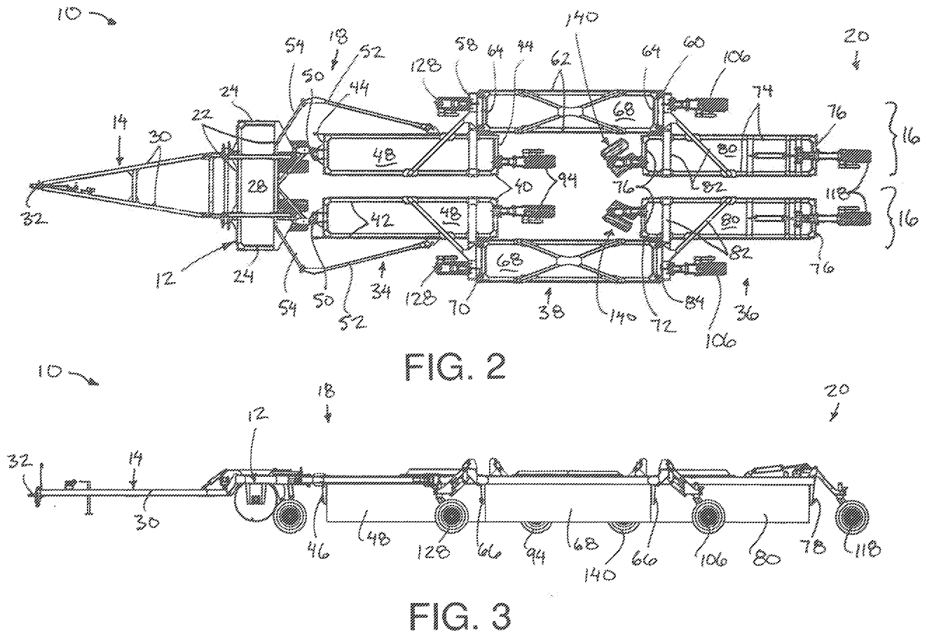

When in the transport configuration with the steerable wheels engaged upon the ground, the steering actuator 148 can be further actuated for controlling the orientation of the wheels about the upright steering axis between (i) a road transport configuration in which the wheel axis is perpendicular to the longitudinal axis of the wing for rolling in the forward working direction in the transport position of the wings and (ii) a field deployment configuration in which the wheel axes of the steerable wheels are oriented transversely to the transport configuration, for example at a slope of between 20 and 70 degrees from the longitudinal axes of the wing assemblies respectively. More preferably the wheels can be steered into an orientation of the wheel axes of approximately 45 degrees from the longitudinal axis of the wing. In the illustrated embodiment of FIG. 2, the wheels are pivoted through a range of less than 30 degrees from the road transport configuration to the field configuration. The steering actuator 148 is a hydraulic actuator which can be locked using valve controls for the hydraulics at any selected position corresponding to the road transport configuration, the field configuration or a selected position between the two. Optionally an additional locking pin 152 may be provided for insertion through cooperating apertures in the pivot frame 142 and the wheel frame 144 to fix the orientation of the wheel frame relative to the pivot frame at any one of numerous selected orientations. All other wheels assemblies can be similarly locked in the transport position if desired.

The steering of the steerable wheels 146 into the field configuration is used to assist in displacing the wings from the working position to the transport position. In the working position of the wing assemblies for use in leveling land, all of the transport wheels are typically raised to be spaced above the ground and out of use. For converting to the transport position, the brace arms 52 are disconnected and all transport wheels are displaced downward into a transport configuration by actuating the appropriate actuators to lift the land leveling rollers off the ground and support the frame of the implement entirely on the transport wheels. The implement is then displaced in the forward working direction using the towing vehicle. The drag of the transport wheels on the ground causes the wings to be gradually displaced from the working position to the transport position in a trailing relationship with the towing vehicle. The steerable wheels can remain locked in the transport configuration while the other wheels remain freely pivotal about the upright axes thereof for road transport. As the towing vehicle executes a turn, the arrangement of the steerable wheels 146 locked in the forward rolling transport configuration define the turning radius of the towed implement while the remaining transport wheels remain freely pivoting as castor wheels to support the weight of the frame sections of the implement without affecting the turning radius during towing.

When it is desirable to displace the implement from the transport position to the working position, the steerable wheels are pivoted into the field configuration thereof by steering both steerable wheel assemblies so that the forward ends of the steerable wheels are displaced inwardly while the rearward ends of the steerable wheels are displaced outwardly resulting in the axes of rotation of the steerable wheel assemblies being sloped rearwardly and inwardly towards one another. Subsequent reversing of the implement by displacing the towing vehicle rearwardly results in the steerable wheels steering the wings outwardly and away from one another towards the working position. Once fully deployed in the working or field position, the brace arms 152 are latched to the main frame section to retain the wings in the working position. All transport wheels are then raised and lifted out of use so that the rollers engage the ground while being oriented for rolling in the forward working direction.

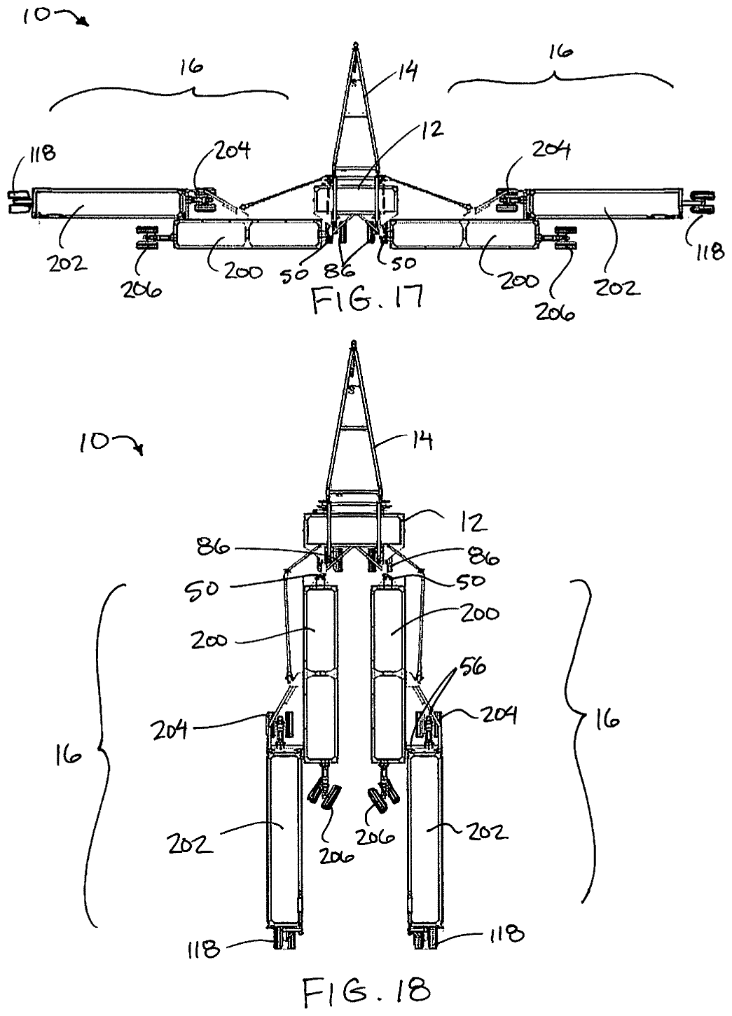

Turning now to FIGS. 17 and 18, a second embodiment of the implement 10 will now be described. In this instance, the structural frame of the implement includes a main frame section 12 with a hitch frame 14 for connection to the towing vehicle in a manner which is identical to the previous embodiment. Also similarly to the previous embodiment, the implement includes two wing assemblies 16 which are coupled that opposing sides of the main frame section. Each wing assembly is again elongate along a respective longitudinal axis from an inner end 18 of the wing assembly that is coupled to the main frame section 12 to an outer end 20 that is distal relative to the main frame section 12. In the working position when the implement is used for leveling land, the wing assemblies are supported to extend laterally outward and opposing directions from the main frame section 12. In the transport position, the two wing assemblies 16 extend rearward from the main frame section 12 to be substantially parallel to one another when towed in the forward working direction.

In the second embodiment, each wing assembly includes only an intermediate frame section 200 at the inner end 18 of the wing assembly and outer frame section 202 which remains at the outer end of the wing assembly. Each intermediate frame section 200 is identical to the inner frame section 34 of the previous embodiment to be coupled at the inner end thereof by suitable pivot couplings 50 at spaced apart positions on the main frame section 12. Each intermediate frame section 200 of the second embodiment thus further includes a mounting frame comprised of two frame members 56 similar to the frame members of the previous embodiment for pivotal connection of a subsequent frame section about a horizontal floating axis oriented perpendicularly to the longitudinal direction of the wing assembly.

Each outer frame section 202 of the second embodiment is nearly identical to the intermediate frame sections 38 described above with regards to the first embodiment. The roller of the outer frame section 202 is thus arranged in longitudinal overlapping configuration with the roller of the intermediate frame section 200 while the outer frame section is offset laterally outwardly relative to the intermediate frame section in the transport position corresponding to the outer frame sections being offset forwardly of the intermediate frame sections in the working position.

The transport wheels in this instance include leading wheel assemblies 86 mounted on the main frame section identically to the leading wheel assemblies of the previous embodiment.

Furthermore, the transport wheels include trailing wheel assemblies 118 which may be identical to the trailing wheel assemblies of the previous embodiment so as to be mounted at the outer end of the outer frame section corresponding to the outer end of the wing assembly and so as to be freely pivotal and self-steering about respective vertical axes.

Furthermore, the transport wheels include intermediate wheel assemblies 204 which are supported to extend forwardly from the inner ends of the outer frame sections in the transport position. The intermediate wheel assemblies 204 are identical to the auxiliary wheel assemblies 128 that extend forward from the intermediate frame sections 38 as described in the previous embodiment.

In this embodiment steerable wheel assemblies 206 are provided which are identical to the steerable wheel assemblies 140 of the previous embodiment with the exception of the steerable wheel assemblies 206 being mounted to extend rearwardly from the intermediate frame sections 200 at the outer ends of the intermediate frame sections in the transport position instead of extending forwardly from the inner ends of the outer frame sections 36 in the previous embodiment. In this manner the parallel links 143 of the steerable wheels 206 extend generally rearwardly to support a vertical pivot shaft on the pivot frame at the rear ends of the links. Each steerable wheel assembly 206 again comprises two steerable wheels 146 which are laterally centred relative to the upright steering axis of the assembly. A steering actuator 148 and a lift actuator 150 are again operatively connected to the steerable wheel assemblies 206 for controlling the implement between working and transport positions of the wing assembly as described above regarding the previous embodiment. By providing the steerable wheel assemblies 206 at a location spaced forwardly of the trailing wheels 118 the same advantages of shortening the turning radius of the implement in the transport position while providing stable support for all of the rollers in a manner similar to the previous embodiment can be achieved. Similar to the previous embodiment, all other transport wheels other than the steerable wheel assemblies 206 are typically freely pivoting and self-steering in a transport position so that the turning radius when towing is dictated solely by the steerable wheel assemblies 206 that are spaced forwardly of the trailing ends of the wing assemblies.

Since various modifications can be made in the invention as herein above described, and many apparently widely different embodiments of same made, it is intended that all matter contained in the accompanying specification shall be interpreted as illustrative only and not in a limiting sense.

1. A land roller implement arranged to be towed in a forward working direction by a towing vehicle for flattening and levelling land, the implement comprising:
a main frame section arranged for connection to the towing vehicle, the main frame section supporting a main roller thereon for rolling movement in the forward working direction;
two wing assemblies extending along respective longitudinal axes from inner ends of the wing assemblies to outer ends of the wing assemblies respectively, the inner ends of the wing assemblies being pivotally coupled at opposing sides of the main frame section respectively whereby the wing assemblies are movable relative to the main frame section between a working position in which the longitudinal axes of the wing assemblies extend laterally outward in opposing directions from the main frame section and a transport position in which the longitudinal axes of the wing assemblies extend rearwardly from the main frame section;
each wing assembly comprising:
(i) an outer frame section at the outer end of the wing assembly, the outer frame section including an outer roller supported thereon for rolling movement in the forward working direction in the working position of the wing assembly;
(ii) an intermediate frame section supported between the outer frame section and the inner end of the wing assembly, the intermediate frame section including an intermediate roller supported thereon for rolling movement in the forward working direction in the working position of the wing assembly; and
(iii) an inner end of the outer frame section being coupled to an outer end of the intermediate frame section;
a set of transport wheels supporting the frame sections for rolling movement in the forward working direction in the transport position, the set of transport wheels including:
(i) two leading wheel assemblies supported on the main frame section;
(ii) two trailing wheel assemblies supported at the outer ends of the outer frame sections respectively, each trailing wheel assembly including at least one trailing wheel; and
(iii) two steerable wheel assemblies supported on the wing assemblies respectively at a location nearer to the inner ends of the wing assemblies than the trailing wheel assemblies, each steerable wheel assembly including an actuating arrangement associated with the steerable wheel assembly, the actuating arrangement being arranged to controllably pivot the steerable wheel about an upright steering axis between a transport configuration oriented for rolling movement about a wheel axis lying perpendicularly to the longitudinal axis of the wing assembly and a field configuration oriented transversely to the transport configuration;
each steerable wheel assembly being supported on the respective wing assembly adjacent to a connection of the inner end of the outer frame section and the outer end of the intermediate frame section; and
said at least one trailing wheel of each trailing wheel assembly is supported for free pivotal movement about an upright caster axis of the trailing wheel assembly and said at least one trailing wheel being laterally centered relative to the caster axis of the trailing wheel assembly in a trailing relationship with the caster axis.

2. The implement according to claim 1 wherein each actuating arrangement is further arranged to lock the associated steerable wheel assembly in the transport configuration.

3. The implement according to claim 1 wherein each actuating arrangement is arranged to pivot the associated steerable wheel assembly between the transport configuration and the field configuration through a range of less than 90 degrees whereby the wheel axis of the steerable wheel assembly is oriented transversely to the longitudinal axis of the wing assembly in the field configuration.

4. The implement according to claim 1 wherein each actuating arrangement is arranged to pivot the associated steerable wheel assembly between the transport configuration and the field configuration through a range of less than 60 degrees.

5. The implement according to claim 1 wherein each actuating arrangement is arranged to pivot the associated steerable wheel assembly between the transport configuration and the field configuration through a range of approximately 45 degrees.

6. The implement according to claim 1 wherein each steerable wheel assembly is supported on a first one of the inner end of the outer frame section or the outer end of the intermediate frame section of the wing assembly, the set of transport wheels further comprising an intermediate wheel assembly supported on each wing assembly, the intermediate wheel assembly being supported on a second one of the inner end of the outer frame section or the outer end of the intermediate frame section of the wing assembly, the intermediate wheel assembly being supported for free pivotal movement about an upright caster axis of the intermediate wheel assembly, and the intermediate wheel assembly comprising at least one intermediate wheel in which said at least one intermediate wheel is laterally centered relative to the caster axis of the intermediate wheel assembly in a trailing relationship with the caster axis.

7. The implement according to claim 1 wherein each steerable wheel assembly is supported on the inner end of the outer frame section of the respective wing assembly.

8. The implement according to claim 7 further comprising two intermediate wheel assemblies supported on the wing assemblies respectively, each intermediate wheel assembly being supported on the outer end of the intermediate frame section of the respective wing assembly, each intermediate wheel assembly being supported for free pivotal movement about an upright caster axis of the intermediate wheel assembly, and the intermediate wheel assembly of each wing assembly comprising at least one intermediate wheel in which said at least one intermediate wheel is laterally centered relative to the caster axis of the intermediate wheel assembly in a trailing relationship with the caster axis.

9. The implement according to claim 7 wherein each wing assembly further comprises an inner frame section supported between the intermediate frame section and the inner end of the wing assembly such that an inner end of the intermediate frame section is supported on an outer end of the inner frame section, the inner frame section including an inner roller supported thereon for rolling movement in the forward working direction in the working position of the wing assembly.

10. The implement according to claim 9 further comprising two inner wheel assemblies supported on the two wing assemblies respectively, each inner wheel assembly being supported on a first one of the outer end of the inner frame section or the inner end of the intermediate frame section of the respective wing assembly, the inner wheel assembly being supported for free pivotal movement about an upright caster axis of the inner wheel assembly, and the inner wheel assembly of each wing assembly comprising at least one inner wheel in which said at least one inner wheel is laterally centered relative to the caster axis of the inner wheel assembly in a trailing relationship with the caster axis.

11. The implement according to claim 10 further comprising two auxiliary wheel assemblies supported on the two wing assemblies respectively, each auxiliary wheel assembly being supported on a second one of the outer end of the inner frame section or the inner end of the intermediate frame section of the respective wing assembly, the auxiliary wheel assembly being supported for free pivotal movement about an upright caster axis of the auxiliary wheel assembly, and the auxiliary wheel assembly of each wing assembly comprising at least one auxiliary wheel in which said at least one auxiliary wheel is laterally centered relative to the caster axis of the auxiliary wheel assembly in a trailing relationship with the caster axis.

12. The implement according to claim 1 wherein each steerable wheel assembly is supported on the outer end of the intermediate frame section of the respective wing assembly.

13. The implement according to claim 12 further comprising two intermediate wheel assembly supported on each wing assembly respectively, each intermediate wheel assembly being supported on the inner end of the outer frame section of the respective wing assembly, each intermediate wheel assembly being supported for free pivotal movement about an upright caster axis of the intermediate wheel assembly, and the intermediate wheel assembly of each wing assembly comprising at least one intermediate wheel in which said at least one intermediate wheel is laterally centered relative to the caster axis of the intermediate wheel assembly in a trailing relationship with the caster axis.

14. The implement according to claim 12 wherein the inner ends of the intermediate frame sections are directly connected to the main frame section.
